(19) United States
(12) Patent Application Publication
(10) Pub. No.: US 2025/0011057 A1
(43) Pub. Date: Jan. 9, 2025

(54) POLYMERIC WRAPPER

(71) Applicant: Sonoco Development, Inc., Hartsville, SC (US)

(72) Inventor: Joseph D. Gagne, Holyoke, MA (US)

(21) Appl. No.: 18/894,381

(22) Filed: Sep. 24, 2024

Related U.S. Application Data
(63) Continuation of application No. 17/981,020, filed on Nov. 4, 2022, now Pat. No. 12,129,088.
Application No. 17/981,020 is a division of application No. 16/996,169, filed on Aug. 18, 2020, now abandoned.
(60) Provisional application No. 62/890,798, filed on Aug. 23, 2019.

(51) Int. Cl. B65D 65/02; B32B 7/02; B32B 27/08; B32B 27/30; B32B 27/32

(52) U.S. Cl. CPC B65D 65/02; B32B 7/02; B32B 27/08; B32B 27/306; B32B 27/32; B32B 2250/05; B32B 2250/246; B32B 2307/72; B32B 2439/70

(57) ABSTRACT

In an embodiment, the invention comprises a wrapper with dead bend characteristics. The wrapper comprises a first polyethylene layer comprising low density polyethylene; a second polyethylene layer affixed to the first layer, wherein the second polyethylene layer comprises high density polyethylene; a first tie layer affixed to the second layer, opposite the first layer; a barrier layer affixed to the tie layer, opposite the second layer; a second tie layer affixed to the barrier layer, opposite the first tie layer; a third polyethylene layer affixed to the second tie layer, opposite the barrier layer, wherein the third polyethylene layer comprises high density polyethylene; and a fourth polyethylene layer affixed to the third polyethylene layer, opposite the second tie layer, wherein the fourth polyethylene layer comprises low density polyethylene. In an embodiment, the tie layers and the barrier layer may be substituted with a cyclic olefin copolymer layer.

### CROSS-REFERENCE TO RELATED APPLICATIONS

This application is a continuation of U.S. Non-Provisional application Ser. No. 17/981,020 filed Nov. 4, 2022, which is a divisional of U.S. Non-Provisional application Ser. No. 16/996,169 filed Aug. 18, 2020, now abandoned, which claims priority to U.S. Provisional Patent Application No. 62/890,798, filed Aug. 23, 2019, entitled “Polymeric Wrapper”, which are incorporated herein in their entirety.

### FIELD OF THE INVENTION

The present invention relates generally to polymeric wrappers and more particularly to polymeric wrappers for candy and gum.

### BACKGROUND OF THE INVENTION

Typical candy and/or gum wrappers are manufactured as laminated composite structures comprising, for example, a paper layer, a polymeric layer, a foil layer, and, optionally, another polymeric layer. The composite nature of the layers may provide a barrier against moisture and condensation, retaining the aroma and flavor of the wrapped product, may allow the display of certain brand or product information, and/or may provide a foldable quality (referred to herein as dead bend or dead fold) to the wrapper.

Wrapping structures such as these, however, are not recyclable due to the composite nature of the wrapper. Through hard work and ingenuity, the inventor has developed an inventive film, sheet, and wrapper structure which is fully recyclable in a single stream recycling process. Further, the inventive film, sheet, and wrapper structure maintains key performance characteristics of composite wrappers, such as lack of curl, tear resistance, dead fold characteristics, barrier qualities, and seal performance.

### SUMMARY OF THE INVENTION

According to an aspect, the present invention provides a structure for a polymeric film, sheet, or wrapper. The inventive film may be a continuous film, disposed on a roll, for example. The inventive sheet may comprise an individual cut sheet of the inventive film, designed to be folded and sealed. The inventive wrapper may comprise a folded and sealed wrapper for candy, cough drops, throat lozenges, gum, or similar products. Though these types of products are contemplated herein, any product known in the art which would benefit from the advantages of the invention (lack of curl, tear resistance, dead fold characteristics, barrier qualities, seal performance) may be wrapped and packaged with the inventive product.

In an embodiment, the inventive composition comprises at least two layers of low density polyethylene (LDPE). Between the layers of LDPE, at least two layers of high density polyethylene (HDPE) may be sandwiched. Between the two layers of HDPE, a layer of either cyclic olefin copolymer (COC) or ethylene vinyl alcohol (EVOH) may be sandwiched. In the EVOH embodiment, tie layers may be utilized between the EVOH and the HDPE layers. In certain embodiments, the exterior LDPE layer may be coated with printed inks, over-lacquers, and/or sealant layers. The sealant may be pattern-applied to various seal regions of the wrapper.

In an embodiment, the invention provides a wrapper comprising: a first polyethylene layer comprising low density polyethylene; a second polyethylene layer affixed to the first layer, wherein the second polyethylene layer comprises high density polyethylene; a first tie layer affixed to the second layer, opposite the first layer; a barrier layer affixed to the tie layer, opposite the second layer; a second tie layer affixed to the barrier layer, opposite the first tie layer; a third polyethylene layer affixed to the second tie layer, opposite the barrier layer, wherein the third polyethylene layer comprises high density polyethylene; and a fourth polyethylene layer affixed to the third polyethylene layer, opposite the second tie layer, wherein the fourth polyethylene layer comprises low density polyethylene; wherein the wrapper has dead bend characteristics.

The wrapper may be twisted about five hundred and forty degrees and, if so, the twisted wrapper substantially retains its twisted state. After the wrapper is opened, it is reclosed by folding or twisting the wrapper and the wrapper substantially retains the fold or twist configuration. The first polyethylene layer may comprise the outer layer of the wrapper. The fourth polyethylene layer may comprise the inner, food contact layer of the wrapper. The barrier layer may comprise ethylene vinyl alcohol and the first tie layer and the second tie layer may each comprise maleic anhydride or a blend of maleic anhydride and polyethylene. The wrapper may not contain foil or paper and may not require the use of a seal or adhesive to close or reclose the wrapper.

In another embodiment, the wrapper may comprise a first polyethylene layer comprising low density polyethylene; a second polyethylene layer affixed to the first layer, wherein the second polyethylene layer comprises high density polyethylene; a cyclic olefin copolymer layer affixed to the second layer, opposite the first layer; a third polyethylene layer affixed to the cyclic olefin copolymer layer, opposite the second polyethylene layer, wherein the third polyethylene layer comprises high density polyethylene; and a fourth polyethylene layer affixed to the third polyethylene layer, opposite the second tie layer, wherein the fourth polyethylene layer comprises low density polyethylene; wherein the wrapper has dead bend characteristics. The cyclic olefin copolymer layer may comprise a barrier layer.

In an embodiment, the invention comprises a method for making a wrapper having dead bend characteristics comprising co-extruding a first polyethylene layer comprising low density polyethylene; a second polyethylene layer affixed to the first layer, wherein the second polyethylene layer comprises high density polyethylene; a first tie layer affixed to the second layer, opposite the first layer; a barrier layer affixed to the tie layer, opposite the second layer; a second tie layer affixed to the barrier layer, opposite the first tie layer; a third polyethylene layer affixed to the second tie layer, opposite the barrier layer, wherein the third polyethylene layer comprises high density polyethylene; and a fourth polyethylene layer affixed to the third polyethylene layer, opposite the second tie layer, wherein the fourth polyethylene layer comprises low density polyethylene; wherein the wrapper has dead bend characteristics. The method may further comprise twisting the wrapper about five hundred and forty degrees. The method may not include the use of a seal or adhesive to close the wrapper.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is cross-sectional view of an embodiment of a film, sheet, or wrapper of the present invention;

FIG. 2 is cross-sectional view of an alternate embodiment of a film, sheet, or wrapper of the present invention; and

FIGS. 3A and 3B are perspective views of a wrapper in an embodiment of the invention.

Repeated use of reference characters in the present specification and drawings is intended to represent the same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Composite wrappers which comprise paper and/or foil layers often remain in a closed condition due to the fact that paper and foil each possess certain dead bend (also referred to as “dead fold”) characteristics. As used herein, the term “dead bend” refers to the ability of a material to remain in a deformed state (or substantially deformed state) or to hold its new conformation (or substantially hold its new conformation) on shaping, whether that comprises a fold, twist, or other shaping method. Generally speaking, polymeric films typically do not have sufficient dead bend characteristics for these types of applications. Rather, polymeric films and plastics have a tendency to spring back or recover to an unfolded state. Surprisingly, however, the inventive polymeric composition has the ability to be dead-folded, that is, to remain in (or substantially remain in) a folded position after folding, creasing, and/or twisting.

In an embodiment, the inventive composition comprises a film, sheet, or wrapper. The inventive composition, according to an embodiment of the invention, may be laminated or co-extruded. The inventive composition, according to an embodiment, may be coated, tinted, untreated, one-side treated, two-side treated, and/or metallized. The inventive composition may be sealable to itself. The inventive composition can be cold-sealed or heat-sealed. The inventive composition can also be adhered or laminated to other materials, in an embodiment, such as polymers (polypropylene, polyethylene or polyester films, for example), foil, paper, foam and other materials known in the art. In a particular embodiment, however, the inventive film is used without a paper, foil, or other composite layer or laminate. This allows recyclability of the inventive film, sheet, or wrapper in a single stream recycling process.

In an embodiment, the films, sheets, and wrappers of the present invention may be utilized for packaging in general and for packaging small items in particular. For example, the inventive films, sheets and wrappers may be utilized to package individual pieces of candy, gum, confections, cough drops, throat lozenges, or the like. In another embodiment, the inventive films, sheets and wrappers may be utilized to package a plurality of pieces of candy, gum, confections, cough drops, throat lozenges, or the like, each of which may, or may not, be individually wrapped. For example, Starburst® candies are each individually wrapped and a plurality of individually wrapped Starburst® candies are also contained in a wrapper. The present invention could be utilized to wrap each individual Starburst® candy and/or to wrap and package a plurality of Starburst® candies, such as in a roll or stack.

In an embodiment, the thickness of the inventive film, sheet, or wrapper may be from about 2 to about 4 mils thick. In another embodiment, the thickness of the inventive film, sheet, or wrapper may be about 3 mils thick. In an embodiment, the inventive film or sheet is flat and curl-free.

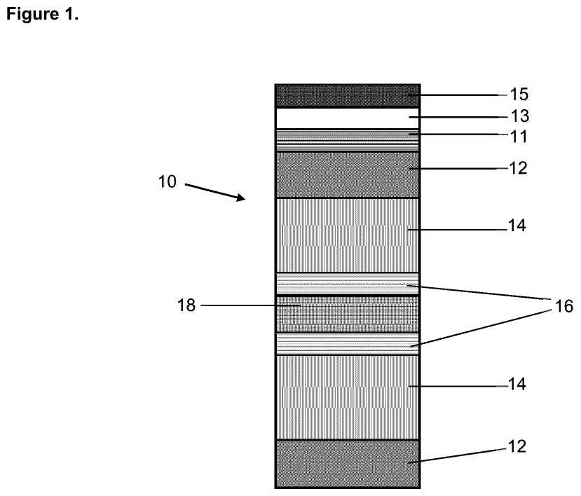

In an embodiment, the inventive film, sheet, or wrapper comprises a plurality of layers. As shown in FIG. 1, in a first embodiment, the inventive sheet 10 may comprise a first layer 12. The first layer 12 may comprise the external layer of the sheet 10 (i.e. disposed furthest from the food product) or may be disposed external of the contents to be contained therein, but may be coated externally, discussed below. In an embodiment, the first layer 12 may comprise low density polyethylene (LDPE). The first layer 12 may be referred to herein as the first LDPE layer 12 and/or the skin layer 12. The first layer 12 may have an outer surface and an inner surface.

In an embodiment, the inner surface of the first layer 12 is laminated to, adhered to or is co-extruded with a second layer 14. In a particular embodiment, the first layer 12 is co-extruded with the second layer 14. In an embodiment, the second layer 14 comprises high density polyethylene (HDPE). The second layer 14 may also be referred to herein as the first HDPE layer 14. In an embodiment, the thickness of the second layer 14 is greater than the thickness of the first layer 12. In an embodiment, the second layer 14 has an inner surface and an outer surface (referring to proximity to the food product). In this embodiment, the inner surface of the first layer 12 may be adjacent and affixed to the outer surface of the second layer 14.

In an embodiment, the inner surface of the second layer 14 is adjacent a first tie layer 16. The tie layer 16 may be any tie layer known in the art. In a particular embodiment, the first layer 12 and the second layer 14 are co-extruded with the first tie layer 16. In an embodiment, the tie layer 16 has an inner surface and an outer surface.

In an embodiment, the inner surface of the first tie layer 16 is disposed adjacent an ethylene vinyl alcohol (EVOH) layer 18. In an embodiment, the EVOH layer 18 comprises a barrier layer for the film, sheet, or wrapper 10. In an embodiment, the EVOH layer 18 is a flexible, clear, glossy thermoplastic copolymer. In an embodiment, the EVOH layer 18 provides flex-crack resistance and exhibits a high resistance to hydrocarbons, oils and organic solvents. In a particular embodiment, the first layer 12 and the second layer 14 are co-extruded with the first tie layer 16 and the EVOH layer. In an embodiment, the EVOH layer 18 has an inner surface and an outer surface.

In an embodiment, the inner surface of the EVOH layer 18 is adjacent a second tie layer 16. The second tie layer 16 may be any tie layer known in the art and may be the same as or different from the first tie layer 16. In an embodiment, the first and second tie layers 16 may each comprise maleic anhydride. In another embodiment, the first and second tie layers 16 may each comprise a maleic anhydride blend with polyethylene. In a particular embodiment, the first layer 12, the second layer 14, the first and second tie layers 16, and the EVOH layer 18 are co-extruded. In an embodiment, the second tie layer 16 has an inner surface and an outer surface.

In an embodiment, the inner surface of the second tie layer 16 is disposed adjacent a second HDPE layer 14. In an embodiment, the second HDPE layer 14 has an inner surface and an outer surface. In this embodiment, the inner surface of the second tie layer 16 may be adjacent the outer surface of the second HDPE layer 14. In a particular embodiment, the first LDPE layer 12, the first HDPE layer 14, the first and second tie layers 16, the EVOH layer 18, and the second HDPE layer 14 are co-extruded.

In an embodiment, the inner surface of the second HDPE layer 14 is disposed adjacent a second LDPE layer 12. In an embodiment, the second LDPE layer 12 has an inner surface and an outer surface. In this embodiment, the inner surface of the second HDPE layer 14 may be adjacent the outer surface of the second LDPE layer 12. In an embodiment, the second LDPE layer 12 may comprise the interior of the film, sheet, or wrapper. In an embodiment, the second LDPE layer 12 may be a food-contact layer. In a particular embodiment, the first LDPE layer 12, the first HDPE layer 14, the first and second tie layers 16, the EVOH layer 18, the second HDPE layer 14, and the second LDPE layer 12 are co-extruded.

Thus, in an embodiment, the second LDPE layer 12 may comprise the interior of the film, sheet, or wrapper and the first LDPE layer 12 may comprise the exterior of the film, sheet, or wrapper. In another embodiment, one or more layers and/or coatings may be disposed exterior of the first LDPE layer 12. In this embodiment, an ink layer 11 may be disposed exterior of the first LDPE layer 12. The ink layer 11 may be printed onto the first LDPE layer 12, in an embodiment. The ink layer 11 may provide color schemes, product information, advertising, logos, etc. Any method of printing, including offset lithography, flexography, screen-printing, digital and gravure, may be utilized herein. After application of the ink layer 11, the film may be run through a drying unit to dry the ink layer 11. In an embodiment, an over-lacquer 13 may be disposed exterior to the ink layer 11.

In an embodiment, a sealant coating 15 may be disposed adjacent the first LDPE layer 12 or the ink layer 11/over-lacquer 13 if they are present. The sealant coating 15 may be pattern-applied in an embodiment. In an embodiment, the sealant coating 15 is surface-printed. In this embodiment, the sealant coating 15 may be applied only within the heat-seal regions of the film, sheet or wrapper. In an embodiment, the sealant coating 15 may comprise various sealant materials such as heat seals or cold seals. Heat seals generally are preferred because they provide stronger seals than cold seals typically are capable of achieving. In this embodiment, any suitable heat seal materials can be employed. In an embodiment, the sealant coating 15 may be applied along at least one longitudinal edge of the film sheet to form a lap or fin seal. In an embodiment, the sealant coating 15 may be additionally applied to opposite ends of the film sheet, perpendicular the longitudinal end, to form end seals. In an embodiment, the end seals comprise tuck and fold corners and/or ends.

In an embodiment, the invention comprises a gum packaging laminate comprising, in order, an LDPE layer, a HDPE layer, a tie layer, an EVOH layer, a tie layer, an HDPE layer, and an LDPE layer. In an embodiment, the exterior LDPE layer is coated with one or more of an ink, an over-lacquer, and a sealant.

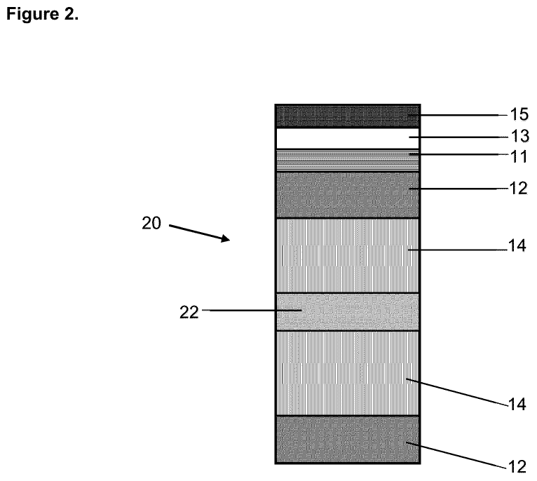

In another embodiment, illustrated in FIG. 2, a layer of cyclic olefin copolymer (COC) 22 may replace the first and second tie layers 16 and the EVOH layer 18 in the inventive film, sheet, or wrapper 20. The COC layer may provide barrier and dead fold characteristics to the film, sheet or wrapper 20. In this embodiment, the first LDPE layer 12, the first HDPE layer 14, the COC layer 22, the second HDPE layer 14, and the second LDPE layer 12 may be co-extruded. The ink layer 11, over-lacquer 13, and/or seal layer 15 may be present in this embodiment of the film, sheet, or wrapper 20.

While EVOH and COC are discussed herein as barrier layers, it should be understood that any barrier material known in the art may be utilized herein.

As discussed herein, the extrusion process used to form the film may comprise a blown film extrusion process or a cast extrusion process, as each are known in the art. Generally speaking, the blown film extrusion process may involve co-extruding the various molten polymers and layers discussed herein through a die and inflating to several times its initial diameter to form a thin film bubble. This bubble is then collapsed and used as a lay-flat film.

In an embodiment, the barrier layer (COC layer 22 or EVOH layer 18) may comprise between about 5% and about 15% of the total thickness of the film, sheet, or wrapper. In an embodiment, the tie layers 16 (if present) may comprise between about 5% and about 15% of the total thickness of the film, sheet, or wrapper. In an embodiment, the HDPE layers 14 may comprise between about 40% and about 70% of the total thickness of the film, sheet, or wrapper. In an embodiment, the LDPE layers 12 may comprise between about 5% and about 15% of the total thickness of the film, sheet, or wrapper.

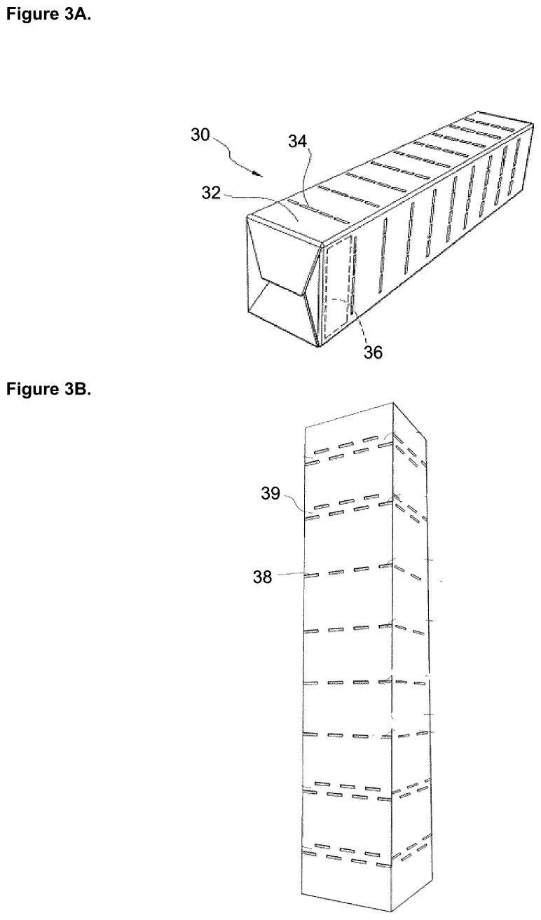

In an embodiment, referring to FIG. 3A and FIG. 3B, the invention comprises a package 30 for supporting and dispensing product pieces 36 arranged in a longitudinally stacked array. In this embodiment, the wrapper may comprise an elongate stick-like package. In this embodiment, the package may comprise a sheet 32 positioned about the stacked product pieces 36. The product pieces 36 may or may not be each individually wrapped. In some embodiments, the package may have a generally cylindrical or rectangular prism configuration. The sheet may include a plurality of longitudinally spaced weakened locations 34 extending transversely to the longitudinal direction of the package. In some embodiments, the weakened locations may be generally parallel to each and perpendicular to a longitudinal axis of the package. Each of the weakened locations may include a single weakened extent 38 or a pair of weakened extents 39 which are closely longitudinally spaced and perpendicular to the longitudinal axis. The weakened extents for each weakened location 34 may be in parallel with each other or each may have an axis or portions that are generally parallel with each other. Each weakened location 34 defines a severable location for the sheet. This wrapper configuration is more fully described in U.S. Pat. No. 9,340,351 to Conlon, et al., which is incorporated herein by reference in its entirety.

The inventive film and/or sheet described herein may be utilized in the formation of a wrapper as set forth in U.S. Pat. No. 9,340,351 to Conlon, et al. The specific layering set forth herein not only provides the barrier and dead fold properties necessary for this type of wrapper, but additionally provides a film or sheet that will lay flat during the manufacturing and wrapper formation process, without curl (or substantially without curl), and the film or sheet can be easily die cut or laser scored, as the case may be. In an embodiment, the die cuts and/or laser scoring necessary to form the wrapper set forth in U.S. Pat. No. 9,340,351 to Conlon, et al. (or any other wrapper which requires die cuts or scoring) may be cut or scored through the outer LDPE layer, the outer HDPE layer and, if present, the tie layer. The die cuts and/or scoring should not extend into the EVOH or COC barrier layer. The structure set forth herein allows for this precision scoring to be accomplished from the inside or the outside of the sheet (i.e. from the top or bottom).

In an embodiment, the inventive film, sheet, and wrapper structure provides satisfactory tear resistance, twist resistance, dead fold characteristics, barrier qualities, and seal performance. In an embodiment, the barrier qualities provide a moisture, oxygen and/or aroma barrier. In an embodiment, the dead fold characteristics of the invention provide dead fold that not only retains its shape upon initial packaging, but additionally aids in reclosing the package and/or wrapper once some product has been removed. That is, when the package is opened and some of the food product is removed, the package may be reclosed by folding or twisting the packaging. The inventive packaging material will retain or substantially retain the fold and/or twist configuration. In an embodiment, the inventive composition does not contain foil or paper and is recyclable in a polyethylene collection stream.

The films according to the present invention may be successfully employed for packaging in general and for packaging small items in particular, by wrapping with lateral and/and longitudinal twist with the aid of high speed machines. For example, films of the invention may be twisted one and a half (1½) times or five hundred and forty degrees (540°). Once so twist wrapped, the twisted film may retain or substantially retain its twisted state and has a reduced tendency to unwrap relative to prior art polymeric films.

In an embodiment, the invention provides improved barrier properties against oxygen and moisture transmission, which are generally not pre-requisites for foldable and/or twist wrapping films because no sealing is generally involved in the packaging. However, the films of the present invention provide improved barrier properties-advantages for the shelf life of the product.

In an embodiment, the invention comprises a method for wrapping gum, candy, or other food products. In another embodiment, the invention comprises a method for making a wrapper which can be folded, twisted, or bent and retains its folded, twisted, or bent configuration after release. In yet another embodiment, the invention comprises a method for making a wrapper which has dead fold qualities. In still another embodiment, the invention comprises a method for making a wrapper which does not require use of an adhesive to reclose the wrapper. In a further embodiment, the invention comprises a method for making a wrapper which retains a food product but does not require use of a seal or adhesive to close the wrapper.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and is not intended to limit the invention so further described in such appended claims. For example, while the layers are discussed in a particular order, it should be understood that the various layers could be reordered and still remain within the scope of the invention. Therefore, the spirit and scope of the appended claims should not be limited to the description of the versions contained therein.

What is claimed is:

1. A product wrapper having dead bend characteristics, comprising:
a first polyethylene layer comprising low density polyethylene;
a second polyethylene layer affixed to the first layer, wherein the second polyethylene layer comprises high density polyethylene;
a first tie layer affixed to the second layer, opposite the first layer;
a barrier layer affixed to the first tie layer, opposite the second layer;
a second tie layer affixed to the barrier layer, opposite the first tie layer;
a third polyethylene layer affixed to the second tie layer, opposite the barrier layer, wherein the third polyethylene layer comprises high density polyethylene; and
a fourth polyethylene layer affixed to the third polyethylene layer, opposite the second tie layer, wherein the fourth polyethylene layer comprises low density polyethylene;
wherein the wrapper is configured to be reclosed using only dead bend properties without the use of an adhesive or seal;
wherein the first tie layer and the second tie layer each consist essentially of a blend comprising:
a minor portion of an amphiphilic polymer; and
a major portion of a non-polar ethylene polymer having a density of 920 to 945 kg/m³; and
wherein the barrier layer comprises ethylene vinyl alcohol having between 20 and 50 mole % ethylene content.

2. The product wrapper of claim 1, wherein each of the second polyethylene layer and third polyethylene layer comprise a non-polar ethylene polymer.

3. The product wrapper of claim 2, wherein the non-polar ethylene polymer in the tie layers is the same as the non-polar ethylene polymer in the second and third polyethylene layers.

4. The product wrapper of claim 1, wherein the amphiphilic polymer comprises 5 to 35 wt % of each tie layer.

5. The product wrapper of claim 1, wherein:
the barrier layer comprises between about 5% and about 15% of the total thickness of the wrapper;
the tie layers each comprise between about 5% and about 15% of the total thickness of the wrapper;
the first and fourth polyethylene layers each comprise between about 5% and about 15% of the total thickness of the wrapper; and
the second and third polyethylene layers each comprise between about 40% and about 70% of the total thickness of the wrapper.

6. The product wrapper of claim 1, wherein the total thickness of the wrapper is between 40-100 μm.

7. A product package comprising:
a plurality of product pieces arranged in a longitudinally stacked array; and
a wrapper according to claim 1 wrapped about the stacked product pieces.

8. The product package of claim 7, wherein the wrapper includes a plurality of longitudinally spaced weakened locations extending transversely to the longitudinal direction of the package, each of the weakened locations defining a severable location for the wrapper.

9. The product package of claim 8, wherein each of the weakened locations includes a single weakened extent or a pair of weakened extents which are closely longitudinally spaced and perpendicular to the longitudinal axis.

10. A product wrapper having dead bend characteristics, comprising:
a first polyethylene layer comprising low density polyethylene;
a second polyethylene layer affixed to the first layer, wherein the second polyethylene layer comprises high density polyethylene;
a cyclic olefin copolymer layer affixed to the second layer, opposite the first layer;
a third polyethylene layer affixed to the cyclic olefin copolymer layer, opposite the second polyethylene layer, wherein the third polyethylene layer comprises high density polyethylene; and
a fourth polyethylene layer affixed to the third polyethylene layer, opposite the cyclic olefin copolymer layer, wherein the fourth polyethylene layer comprises low density polyethylene;
wherein the wrapper is configured to be closed using only dead bend properties without the use of an adhesive or seal.

11. The product wrapper of claim 10, wherein the cyclic olefin copolymer layer provides an oxygen barrier with an oxygen transmission rate of less than 20 cm³/m²/day under standard conditions.

12. The product wrapper of claim 10, wherein:
the cyclic olefin copolymer layer comprises between about 5% and about 15% of the total thickness of the wrapper;
the first and fourth polyethylene layers each comprise between about 5% and about 15% of the total thickness of the wrapper; and
the second and third polyethylene layers each comprise between about 40% and about 70% of the total thickness of the wrapper.

13. A product package comprising:
a plurality of product pieces arranged in a longitudinally stacked array; and
a wrapper according to claim 10 wrapped about the stacked product pieces.

14. The product package of claim 13, wherein the wrapper includes a plurality of longitudinally spaced weakened locations extending transversely to the longitudinal direction of the package, each of the weakened locations defining a severable location for the wrapper.

15. The product package of claim 14, wherein each of the weakened locations includes a single weakened extent or a pair of weakened extents which are closely longitudinally spaced and perpendicular to the longitudinal axis.

16. A product wrapper having dead bend characteristics, comprising:
a first polyethylene layer comprising low density polyethylene;
a second polyethylene layer affixed to the first layer, wherein the second polyethylene layer comprises high density polyethylene;
a cyclic olefin copolymer layer affixed to the second layer, opposite the first layer;
a third polyethylene layer affixed to the cyclic olefin copolymer layer, opposite the second polyethylene layer, wherein the third polyethylene layer comprises high density polyethylene; and
a fourth polyethylene layer affixed to the third polyethylene layer, opposite the cyclic olefin copolymer layer, wherein the fourth polyethylene layer comprises low density polyethylene;
wherein the wrapper is configured to be closed using only dead bend properties without the use of an adhesive or seal;
wherein the cyclic olefin copolymer layer provides an oxygen barrier with an oxygen transmission rate of less than 10 cm³/m²/day under standard conditions;
wherein the cyclic olefin copolymer layer comprises between 5% and 15% of the total thickness of the wrapper;
wherein the first and fourth polyethylene layers each comprise between 5% and 15% of the total thickness of the wrapper;
wherein the second and third polyethylene layers each comprise between 40% and 70% of the total thickness of the wrapper; and
wherein the total thickness of the wrapper is between 40-100 μm.

17. A product package comprising:
a plurality of product pieces arranged in a longitudinally stacked array; and
a wrapper according to claim 10 wrapped about the stacked product pieces.

18. The product package of claim 13, wherein the wrapper includes a plurality of longitudinally spaced weakened locations extending transversely to the longitudinal direction of the package, each of the weakened locations defining a severable location for the wrapper.

19. The product package of claim 14, wherein each of the weakened locations includes a single weakened extent or a pair of weakened extents which are closely longitudinally spaced and perpendicular to the longitudinal axis.
